(19) United States
(12) Patent Application Publication
(10) Pub. No.: US 2014/0365364 A1
(43) Pub. Date: Dec. 11, 2014

(54) METHOD OF PAYMENT FOR A PRODUCT OR A SERVICE ON A COMMERCIAL SITE THROUGH AN INTERNET CONNECTION AND A CORRESPONDING TERMINAL

(71) Applicant: GEMALTO SA, Meudon (FR)

(72) Inventors: Virginie Coupe, Meudon (FR); Katarzyna Czapska, Meudon (FR); Riadh Jaafar, Meudon (FR); Hon-Kuan Lee, Meudon (FR); Anna-Maija Muroke, Meudon (FR); Christophe Picatto, Meudon (FR); Liu Xu, Meudon (FR)

(73) Assignee: Gemalto SA, Meudon (FR)

(21) Appl. No.: 14/349,877

(22) PCT Filed: Oct. 4, 2012
(86) PCT No.: PCT/EP2012/069659

§ 371 Date: Jul. 24, 2014

(30) Foreign Application Priority Data
Oct. 6, 2011 (EP) 11306297.0

(51) Int. Cl. G06Q 20/32; G06Q 20/34

(52) U.S. Cl. CPC G06Q 20/3278; G06Q 20/34
USPC 705/41

(57) ABSTRACT

The invention relates to a method of payment for a product or a service on a commercial website through an Internet connection and a terminal that is connected to the commercial website via the Internet connection, with the payment being made using at least one identifier contained in a payment card. According to the invention, the terminal comprises an interface of the NFC type that reads the aforementioned banking identifier contained in the payment card, with the payment card being of the NFC type, and the terminal having an application able to transmit the identifier to a dedicated server on a secure link which the commercial website is connected to after the identifier has been read by the terminal, with the dedicated server concatenating the payment characteristics before transmitting same to the bank site.

The field of the invention is that of telecommunications and more specifically relates to a method of payment over the Internet for a product or a service on a commercial website using a terminal connected to such commercial site. A commercial website is a site offering a potential buyer products or services that can be remotely ordered and paid for.

The terminal may be a home computer, or a laptop computer, or for example a mobile phone connected to the commercial site via the Internet.

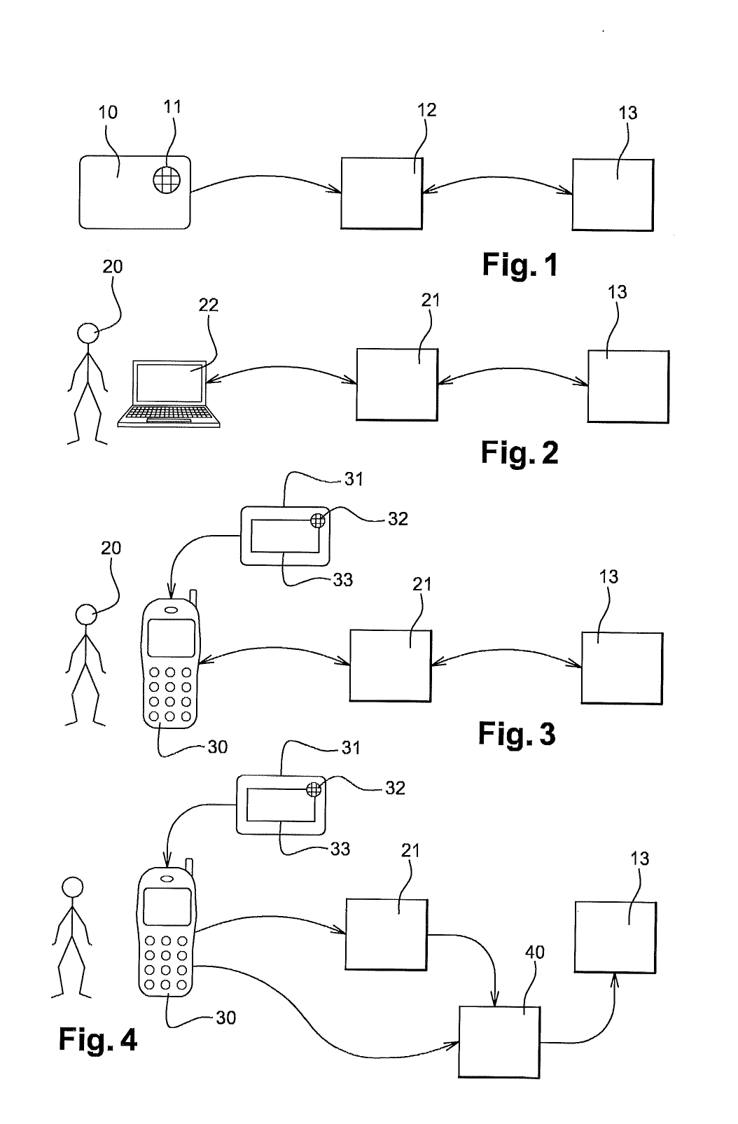

FIG. 1 shows a conventional payment system used to pay a retailer for a product or a service. The user pays with his/her bank card 10 typically provided with an electronic chip 11. To pay for the transaction, the user inserts his/her bank card 10 into a payment terminal 12 which is connected to a bank payment server 13 via the Internet. A secure communication is established between the payment terminal 12 and the bank payment server 13. The payment terminal 12 indicates the transaction, the type of the transaction, which payment terminal 12 was used with a key of the payment terminal 12. Such data is checked by the bank payment server 13 and, if the transaction is authorized, the seller is notified and the buyer gets the product or the service.

FIG. 2 shows an online payment system wherein a user 20 connects to a commercial site 21 through an Internet connection using a terminal 22, for instance a portable terminal, such as a computer. After shopping, the user 20 accesses a payment web page including identifier entry fields. These typically are a field asking for the number of the user's credit card 20, the expiry date of the bank card, and a field wherein the user must enter a security code noted on the back of his/her bank card. The user 20 enters the information into the various fields using the keyboard of the terminal 22. Once all fields have been filled, these are sent to a bank payment server 13 which checks that the transaction is authorized. The commercial site 21 is then notified as is the user 20 via the terminal 22.

The disadvantage of the system shown in FIG. 2, is that the user 20 must manually enter his/her ID (card number, expiry date, security code) into the terminal 22 in order to make the payment. In addition, data entry errors may occur, which requires the user 20 to start entering his/her identifiers again, from the beginning.

Terminals able to communicate with other elements via NFC devices are also known. For example, more and more mobile terminals such as mobile phones are equipped with NFC functionalities enabling, for example, to clear walk-through units in the metro, to pay for tickets, or to read tags from a short distance.

The present invention is more particularly intended to simplify the online purchase of products or services (i.e. via the Internet), using a terminal connected to a commercial site, with such terminal including functionalities of the NFC type.

For this purpose, the present invention provides for a method of payment for a product or a service on a commercial site through an Internet connection and a terminal connected to the commercial site on the Internet, with the method consisting in entering the buyer's bank identifier into an identifier entry field on a page of the commercial site or a page of a bank site connected to the commercial site, with the terminal having an interface of the NFC type comprising means for reading the bank identifier contained in the buyer's payment card of the NFC type and the terminal comprises an application including means for transmitting this identifier and writing same into the entry field, after the payment card has been placed close to the terminal so that a communication of the NFC type can be established in order to automatically fill the entry field without any action by the buyer.

Advantageously, the payment card of the NFC type also includes contact reading/writing means.

According to a preferred embodiment of the invention, the terminal is a mobile phone.

The application advantageously sends the identifier on a secure link which the commercial site is connected to, with the dedicated server concatenating the payment characteristics before sending same to the bank site.

The invention also relates to a terminal comprising an interface of the NFC type comprising means for reading a bank identifier contained in a buyer's payment card of the NFC type, with the terminal comprising an application provided with means for transmitting this identifier and writing same into a payment page entry field, after the payment card has been placed close to the terminal so that a communication of the NFC type can be established in order to automatically fill the entry field without any action by the buyer.

Other characteristics and advantages of the invention will become apparent upon reading the following description of the figures showing an online payment system, given as an illustration and not as a limitation, wherein:

FIG. 3 shows a schematic diagram of an online payment implementing the method according to the present invention;

FIG. 4 is a more secure system than that of FIG. 1 also implementing the method according to the present invention.

FIGS. 1 and 2 have been described with reference to the state of the art.

FIG. 3 shows the simplified schematic diagram of an online payment implementing the method of the present invention.

In this figure, a user 20 accesses a commercial website 21 using a terminal 30 comprising a functionality of the NFC type. The terminal 30 is connected to the commercial site 21 via the Internet. The user 20 has a card 31, for example his/her bank card provided with a chip 32 connected to an antenna 33 giving it a NFC is functionality. The terminal 30 is able to read confidential data contained in the chip 32. When the user has shopped online and is presented with a page that includes one or more identifier entry field(s), the present invention provides an application (an applet if it is of the Java type) installed in the terminal 30 able to read the confidential data contained in the chip 32 via NFC. The user activates a contactless payment functionality on his/her terminal for the confidential data such as the account number, the expiry date of the card 31, the security code, possibly the type of the bank card to be automatically transmitted from the card 31 to the terminal 30. The application installed in the terminal 30 then sends the confidential data to the commercial site 21. The fields to be filled to complete the payment of the transaction are automatically filled without any action by the user 20. The exchange of data between the commercial site 21 and the bank server 13 is carried out as explained with reference to FIG. 2. The advantage of this solution is that the user just has to place his/her card 31 close to the mobile terminal 30 (after choosing a “contactless” payment method on the commercial site 21, a “Paypal” type option for example) for the confidential data enabling to identify his/her card 31 to be transmitted to the commercial site 21. The user therefore no longer has to manually enter his/her confidential data and there is no risk of an error occurring while entering the data.

To securely transmit the sensitive data between the card 31 and the bank server 13, a more secure diagram shown in FIG. 4 involves a dedicated server 40, the function of which is to check the presence of the card 31 in the terminal 30, possibly to prompt the user to enter a PIN code to authenticate the transaction and to create a data packet including all said data, including the confidential data contained in the card 31 and to submit this data packet to the bank server 13. The connection between the terminal 30 and the dedicated server 40 is a secure link, for instance of the https type. The application installed in the terminal 30 combined with the secure link with the dedicated server 40 fulfils the same function as the payment terminal 12 of FIG. 1. The data required for the transaction are also sent from the commercial site 21 to the dedicated server 40. In this embodiment, the technical solution is thus based on two elements which, when combined, form a physical point of sale (POS) enabling to make a payment transaction:
an application in the mobile terminal 30 enabling to access the information contained in the payment card 31 without any contact;
a payment and authentication server 40 accessible via the Internet that authenticates the card and transmits the transaction data to a bank server 13 (the merchant's bank server or a global payment network such as Visa, for example).

The invention therefore makes it possible to keep secret the bank information contained in the card 31 (the commercial site does not store information), to increase security by requiring the physical use of the card 31 and optionally also the entry of a PIN code. In addition, the application included in the terminal 30 can be downloaded from the payment page of the commercial site 21.

The commercial site 21 also has a lower risk of not being paid, for example in the case of theft of the confidential information contained in the card 31.

Finally, the invention reduces fraudulent payments on the Internet and gives the bank an advantage over competitors which do not have this option available to the user to make a payment via NFC by simply placing his/her card 31 close to the terminal 30.

The invention is particularly applicable to the cards using the EMV technology based on the DDA (Dynamic Data Authentication) technology. Each card contains a private key and a crypto-processor enabling it to generate a unique signature for each transaction.

This unique signature is based on random data, which is different for each use. As a matter of fact, the authentication elements are provided to the electronic payment terminal by the card itself. The invention also applies to EMV cards of the SDA (Static Data Authentication) type which were used before the cards of the DDA type. The SDA mode would enable crooks to duplicate the customer's data during the “static” phase of the chip authentication. The DDA mode completely eliminates this type of fraud by making the authentication phase “dynamic”.

The invention also relates to a terminal comprising an interface of the NFC type comprising means for reading a bank identifier contained in a buyer's payment card of the NFC type. The terminal is provided with an application containing means for transmitting this identifier and writing same into a payment page entry field after the payment card has been placed close to the terminal so that a communication of the NFC type can be established in order to automatically fill the entry field without any action by the buyer.

1-5. (canceled)

6. A method of payment for a product or a service on a commercial site through an Internet connection and a terminal connected to said commercial site via said Internet connection, with the payment being made using at least one identifier contained in a payment card, wherein
said terminal comprises an interface of the NFC type and is configured to read a banking identifier contained in said payment card, and said payment card being of the NFC type,
said terminal comprises an application configured to transmit said identifier to a dedicated server on a secure link to which said commercial website is connected after said identifier has been read by said terminal, and
said dedicated server concatenates the characteristics of said payment before transmitting same to a bank site.

7. A method according to claim 6, wherein said payment card of the NFC type also comprises contacts for reading/writing.

8. A method according to claim 6, wherein said terminal is a mobile phone.

9. A system comprising a terminal having an interface of the NFC type for communicating with a buyer's payment card of the NFC type that contains a bank identifier, and a dedicated server on a secure link to which a commercial website is connected,
wherein said terminal comprises means for reading said bank identifier contained in said payment card, and further comprising an application configured to transmit said identifier to the dedicated server after the identifier has been read by said terminal,
and wherein said dedicated server is configured to concatenate characteristics of said payment before transmitting same to a bank site.
